(19) United States
(12) Patent Application Publication
(10) Pub. No.: US 2020/0179914 A1
(43) Pub. Date: Jun. 11, 2020

(54) METHOD FOR PRODUCING CATALYST

(71) Applicant: Polyplastics Co., Ltd., Tokyo (JP)

(72) Inventor: Naohiro KIRAI, Fuji-shi (JP)

(21) Appl. No.: 16/310,959

(22) PCT Filed: May 31, 2017
(86) PCT No.: PCT/JP2017/020307

§ 371 Date: Dec. 18, 2018

(30) Foreign Application Priority Data
Jun. 29, 2016 (JP) 2016-129025

(51) Int. Cl. B01J 31/16

(52) U.S. Cl. CPC B01J 31/1633; B01J 2531/0205; B01J 2531/46; B01J 2531/48; B01J 2531/49

(57) ABSTRACT

A production method for a catalyst, in which a catalyst that is a metallocene compound can be produced with high purity and high yield using a ligand of a specific structure containing a fluorene skeleton. The catalyst is produced by a method including a step (I) in which a ligand of a specific structure containing a fluorene skeleton is reacted with a specific amount of an organic lithium compound of a specific structure; a step (II) in which the product of step (I) is reacted with one or more of Mg compounds of a predetermined structure, Zn compounds of a predetermined structure and Al compounds of a predetermined structure; and a step (III) in which the product of step (II) is reacted with at least 1 molar equivalent, with respect to the ligand, of a Ti compound, a Zr compound or an Hf compound, the compound having a halogen atom or the like.

### TECHNICAL FIELD

The present invention relates to a method of manufacturing a catalyst.

### BACKGROUND ART

Conventionally, so-called metallocene catalysts in which various ligands are coordinated to metal atoms are widely used as catalysts for polymerization of a monomer compound having an unsaturated double bond. Specifically, for example, a catalyst having the following structure is known to favorably facilitate copolymerization of α-olefin-norbornene (see Nonpatent Document 1).

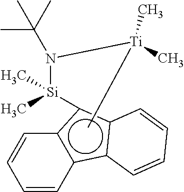

It is noted that the catalyst having the above structure described in Nonpatent Document 1 can encompass a plurality of different complexes having mutually different hapticities in equilibrium such that the fluorene ligands are differently coordinated to Ti as described below. Here, when a fluorene ligand is used, the number of hapticity ranges from 1 to 5. In the following scheme, a complex with a hapticity of 5 (η⁵), a complex with a hapticity of 3 (η³), and a complex with a hapticity of 1 (η¹) are in equilibrium.

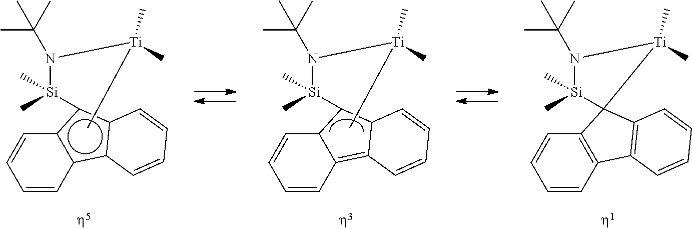

In a case where a sigma ligand of the central metal atom is an alkyl or aryl group, a metallocene catalyst can usually be obtained according to a method including the following steps of:

1) allowing an appropriate ligand to react with MX₄ wherein X represents a halogen atom (usually TiCl₄ or ZrCl₄) to manufacture a metallocene dihalide (usually metallocene dichloride); and
2) converting the metallocene dihalide obtained from step 1) into a corresponding dialkyl or diaryl complex by replacing a halogen atom attached to the metal atom with a desired alkyl or aryl group using an alkylating agent (for example, alkyllithium, dialkylmagnesium, or a corresponding Grignard reagent) (see Patent Document 1). Nevertheless, the above metallocene cannot conveniently be synthesized by a well-known methodology such as the one disclosed in Patent Document 1. Actually, the conventional methods always involve a step of synthesizing a metallocene dihalide which is sequentially converted into a product of interest. For this reason, the conventional methods suffer from unsatisfactory overall yields due to the necessity of at least two steps.

If the catalyst having the above structure described in Nonpatent Document 1 is to be manufactured in accordance with the method described in Patent Document 1, a ligand having the following structure is allowed to react with 4 molar equivalents or more of a methylated alkali metal compound such as methyllithium, or a Grignard reagent having a methyl group such as methylmagnesium bromide, and subsequently allowing the resulting product to react with a metal compound such as TiCl₄. The general formula in which the ligand having the following structure is shown is included in Patent Document 1. It is noted that the lower limit of the usage amount of methyllithium or methylmagnesium bromide is defined as 4 molar equivalents in Patent Document 1. The value represents the minimum amount required stoichiometrically for manufacturing the catalyst having the above structure using the ligand having the following structure. It is also noted that the catalyst is manufactured in a single-pot operation in Patent Document 1.

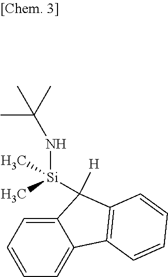

Patent Document 1: Japanese Unexamined Patent Application (Translation of PCT Application), Publication No. 2001-516367

Non-Patent Document 1: Living polymerization of olefins with ansa-dimethylsilylene(fluorenyl)(amido)dimethyltitanium-based catalysts, Takeshi Shiono, Polymer Journal, 2011, 43, p. 331-351

Non-Patent Document 2: Stereospecific polymerization of propylene with group 4 ansa-fluorenylamidodimethyl complexes, Takeshi Shiono et al., Journal of Organometallic Chemistry, 2006, vol. 691, p.193-201

DISCLOSURE OF THE INVENTION

### Problems to be Solved by the Invention

Indeed, the method described in Patent Document 1 can be used to manufacture a metallocene catalyst in a high yield. The method described in Patent Document 1, however, can not necessarily produce a highly pure catalyst in a good yield when manufacturing the catalyst having the above structure as described in Nonpatent Document 1 or a catalyst having a structure similar to that of the above catalyst. Further, Nonpatent Document 2 describes a method of manufacturing the catalyst having the above structure as described in Nonpatent Document 1, in which methyllithium in an amount of 5.3 molar equivalents relative to a ligand is allowed to react, and then TiCl₄ is allowed to react. Nonetheless, a highly pure catalyst cannot readily be manufactured in a high yield even if the method described in Nonpatent Document 2 is used. It is noted that a specific embodiment of the method as described in Nonpatent Document 2 may be considered to be encompassed by the method as described in Patent Document 1.

The present invention is made in view of the above problems. An object of the present invention is to provide a method of manufacturing a catalyst, which is capable of manufacturing a highly pure catalytic metallocene compound in a high yield using a ligand having a specific structure including a fluorene skeleton.

### Means for Solving the Problems

The present inventors found that a method involving the following steps is capable of solving the above problems: a step (I) of allowing a ligand having a specific structure including a fluorene skeleton to react with a specific amount of an organolithium compound having a specific structure; a step (II) of allowing a product from step (I) to react with one or more selected from the group consisting of a Mg compound having a specific structure, a Zn compound having a specific structure, and an Al compound having a specific structure; and a step (III) of allowing a product from step (II) to react with a Ti compound having a halogen atom and others, a Zr compound having a halogen atom and others, or a Hf compound having a halogen atom and others in an amount of 1 molar equivalent or more relative to the ligand. The present invention was thus completed. More specifically, the present invention can provide the followings.

(1) A method of manufacturing a catalyst represented by the following formula (1):

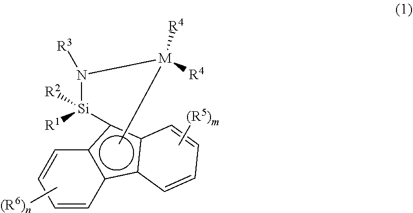

wherein in the formula (1), R¹, R², R³, and R⁴ each independently represent a hydrocarbon group having 1 to 20 carbon atoms and optionally having at least one hetero atom; R¹ and R² are each attached to the silicon atom via a C—Si bond, an O—Si bond, a Si—Si bond, or a N—Si bond; R³ is attached to the nitrogen atom via a C—N bond, an O—N bond, a Si—N bond, or a N—N bond; R⁴ is attached to the metal atom M via a C—M bond; R⁵ and R⁶ each independently represent an organic substituent having 1 to 20 carbon atoms and optionally having at least one hetero atom, or an inorganic substituent; m and n each independently represent an integer of 0 to 4; if a plurality of Rs⁵ and a plurality of Rs⁶ are present, the plurality of Rs⁵ and the plurality of Rs⁶ are each optionally a different group; if two groups of the plurality of Rs⁵ or two groups of the plurality of Rs⁶ are attached to respective positions adjacent to each other on the aromatic ring, the two groups are optionally joined together to form a ring; M is Ti, Zr, or Hf; the method including:
a step (I) of allowing a ligand represented by the following formula (1a):

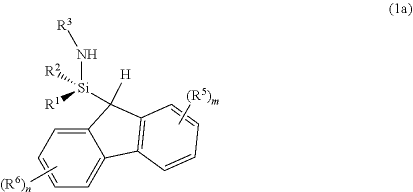

wherein in the formula (1a) , R¹, R², R³, R⁵, R⁶, m, and n are as defined in the above,
to react with an organolithium compound represented by the following formula (1b):

LiR⁷ (1b)

wherein in the formula (1 b), R⁷ represents a hydrocarbon group having 1 to 20 carbon atoms and optionally having at least one hetero atom, and is attached to the lithium atom via a C—Li bond; a step (II) of allowing a product obtained from step (I) to react with one or more selected from the group consisting of a compound represented by the following (1c), a compound represented by the following (1d), and a compound represented by the following (1e):

(R⁴)ₚMgX₍₂₋ₚ₎ (1c)

(R⁴)_{q}ZnX_{(2-q)} (1d)

(R⁴)ᵣAlX₍₃₋ᵣ₎ (1e)

wherein in the formulae (1c), (1d), and (1e), R⁴ is as defined in the above; X is a halogen atom; p is 1 or 2; q is 1 or 2; and r is an integer of 1 to 3; and a step (III) of allowing a product obtained from step (II) to react with a compound represented by the following formula (1f) in an amount of 1 molar equivalent or more relative to the ligand:

MR⁸₄ (1f)

wherein in the formula (1f), M is as defined in the above; R⁸ represents a halogen atom or a group represented by —OR⁹; R⁹ represents a hydrocarbon group having 1 to 20 carbon atoms and optionally having at least one hetero atom; and R⁹ is attached to an oxygen atom via a C—O bond,
wherein in step (I), the usage amount of the organolithium compound is 2.0 molar equivalents or more relative to the ligand if R⁴ and R⁷ are the same, and
in step (I), the usage amount of the organolithium compound is 1.8 molar equivalents or more and 2.2 molar equivalents or less relative to the ligand if R⁴ and R⁷ are not the same, and
in step (II), a compound selected from the group consisting of the compound represented by the formula (1c), the compound represented by the formula (1d), and the group represented by (1e) is used in an amount such that the number of moles of the R⁴ group in each of these compounds is larger by 2 times or more than that of the ligand.

(2) The method of manufacturing a catalyst according to (1), wherein the ligand is a compound represented by the formula (1a-1):

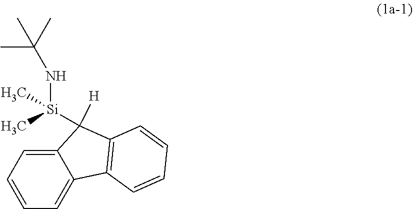

(3) The method of manufacturing a catalyst according to (1) or (2), wherein the product obtained from step (I) is allowed to react with the compound represented by the formula (1c) in step (II).

(4) The method of manufacturing a catalyst according to any one of (1) to (3), wherein the compound represented by the formula (1f) is TiCl₄.

### Effects of the Invention

The present invention can provide a method of manufacturing a catalyst in which a catalytic metallocene compound can be manufactured in high purity and high yield using a ligand having a specific structure including a fluorene skeleton.

### PREFERRED MODE FOR CARRYING OUT THE INVENTION

### Method of Manufacturing Catalyst

In the method of manufacturing a catalyst according to an embodiment of the present invention, a catalyst having a structure represented by the formula (1) described below is manufactured. Further, the method of manufacturing a catalyst according to an embodiment the present invention includes:

a step (I) of allowing a ligand represented by the formula (1a) to react with an organolithium compound represented by the formula (1b), the both being as described below;
a step (II) of allowing a product obtained from step (I) to react with one or more selected from the group consisting of a Mg compound having a specific structure, a Zn compound having a specific structure, and an Al compound having a specific structure; and a step (III) of allowing a product obtained from step (II) to react with a metal compound represented by the formula (1f) described below in an amount of 1 molar equivalent or more relative to the ligand. According to the method as described above, a compound obtained from a reaction of the two organometallic compounds used in steps (I) and (II) and the ligand is allowed to react with a metal halogen compound or the like in step (II). This can prevent side reactions, producing a highly pure catalyst in a high yield. Below, the catalyst, step (I), step (II), step (III) as well as additional steps will be described.

### Catalyst

First, a catalyst to be manufactured by the method according to an embodiment of the present invention will be described. A catalyst having a structure represented by the following formula (1) including a ligand having a fluorene skeleton may be manufactured by the method according to an embodiment of the present invention.

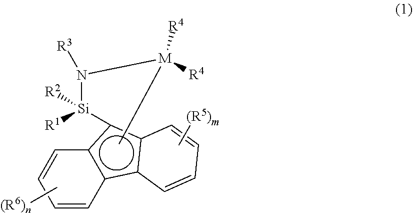

In the formula (1) , R¹, R², R³, and R⁴ each independently represent a hydrocarbon group having 1 to 20 carbon atoms and optionally having at least one hetero atom. R¹ and R² are each attached to the silicon atom via a C—Si bond, an O—Si bond, a Si—Si bond, or a N—Si bond. R³ is attached to the nitrogen atom via a C—N bond, an O—N bond, a Si—N bond, or a N—N bond. R⁴ is attached to the metal atom M via a C—M bond. R⁵ and R⁶ each independently represent an organic substituent having 1 to 20 carbon atoms and optionally having at least one hetero atom, or an inorganic substituent; and m and n are each independently an integer of 0 to 4. If a plurality of R⁵s and a plurality of R⁶s are present, the plurality of R⁵s and the plurality of R⁶s are each optionally a different group. If two groups of the plurality of R⁵s or two groups of the plurality of R⁶s are attached to respective positions adjacent to each other on the aromatic ring, the two groups are optionally joined together to form a ring. M is Ti, Zr, or Hf.

It is noted that the metal atom M in the formula (1) may be coordinated in any configuration to a ligand having a fluorene skeleton as long as the number of hapticity ranges from 1 to 5.

R¹, R², R³, and R⁴ each independently represent a hydrocarbon group having 1 to 20 carbon atoms and optionally having at least one hetero atom. In a case where the hydrocarbon groups include at least one hetero atom, there is no particular limitation for the type of the at least one hetero atom as long as the object of the present invention can be achieved. Specific examples of the at least one hetero atom include an oxygen atom, a nitrogen atom, a sulfur atom, a phosphorus atom, a silicon atom, a selenium atom, a halogen atom, and the like.

In a case where the hydrocarbon groups include at least one hetero atom, there is no particular limitation for the number of hetero atoms. In a case where the hydrocarbon groups include at least one hetero atom, the total of the number of carbon atoms and the number of hetero atoms is preferably 30 or less, more preferably 25 or less, and in particular preferably 20 or less. In a case where the hydrocarbon groups include at least one hetero atom, the number of hetero atoms is preferably 10 or less, more preferably 5 or less, and in particular preferably 3 or less.

Examples of a hetero atom-involving bond optionally included in the hydrocarbon groups include, for example, —O—, —C(═O)—, —C(═O)—O—, —C(═O)—O—C(═O)—, —O—C(═O)—O—, —C(═O)—N<, >N—C(═O)—N<, —S—, —S(═O)—, —S(═O)₂—, —S—S—, —C(═O)—S—, —C(═S)—O—, —C(═S)—S—, —C(═S)—N<, —N═, —N<, —N═N—, ═N—O—, ═N—S—, ═N—N<, ═N—Se—, —S(═O)₂—N<, —C═N—O—, —P<, —P(═O)<, —Se—, —Se(═O)—, >Si<, and a siloxane bond. The hydrocarbon groups may include these hetero atom-involving bonds alone, or in combination of two or more.

R¹ and R² are each attached to the silicon atom via a C—Si bond, an O—Si bond, a Si—Si bond, or a N—Si bond. Suitable examples of R¹ and R² attached to the silicon atom via an O—Si bond include groups represented by —OR and —O—C(═O)—R. Suitable examples of R¹ and R² attached to the silicon atom via a Si—Si bond include groups represented by —SiR₃, —Si(OR)R₂, —Si(OR)₂R, and —Si(OR)₃. Suitable examples of R¹ and R² attached to the silicon atom via a N—Si bond include groups represented by —NHR and —NR₂. Here, Rs in the above are each a hydrocarbon group.

R³ is attached to the nitrogen atom via a C—N bond, an O—N bond, a Si—N bond, or a N—N bond. Suitable examples of R³ attached to the nitrogen atom via an O—N bond include groups represented by —OR and —O—C(═O)—R. Suitable examples of R³ attached to the nitrogen atom via a Si—N bond include groups represented by —SiR₃, —Si(OR)R₂, —Si(OR)₂R, and —Si(OR)₃. Suitable examples of R³ attached to the nitrogen atom via a N—N bond include groups represented by —NHR and —NR₂. Here, Rs in the above are each a hydrocarbon group.

R¹ and R² are preferably the same group in view of easiness of preparation and availability of a compound used as a ligand.

R¹, R², R³, and R⁴ are each preferably a hydrocarbon group having no hetero atoms in view of excellent chemical stability. Examples of such a hydrocarbon group preferably include a linear or branched alkyl group, a linear or branched unsaturated aliphatic hydrocarbon group optionally having a double bond and/or a triple bond, a cycloalkyl group, a cycloalkylalkyl group, an aromatic hydrocarbon group, and an aralkyl group.

Specific examples of the linear or branched alkyl group include a methyl group, an ethyl group, an n-propyl group, an isopropyl group, an n-butyl group, an isobutyl group, a sec-butyl group, a tert-butyl group, an n-pentyl group, an isopentyl group, a tert-pentyl group, an n-hexyl group, an n-heptyl group, an n-octyl group, 2-ethylhexyl group, an n-nonyl group, an n-decyl group, an n-undecyl group, an n-dodecyl, an n-tridecyl group, an n-tetradecyl group, an n-pentadecyl group, an n-hexadecyl group, an n-heptadecyl group, an n-octadecyl group, an n-nonadecyl group, and an n-icosyl group.

Preferred examples of the linear or branched unsaturated aliphatic hydrocarbon group optionally having a double bond and/or a triple bond include a group in which one or more single bonds are each replaced with a double bond and/or a triple bond in a group exemplified as a specific example of a linear or branched alkyl group. More preferred examples include a vinyl group, an allyl group, 1-propenyl group, 3-butenyl group, 2-butenyl group, 1-butenyl group, an ethenyl group, and a propargyl group.

Specific examples of the cycloalkyl group include a cyclopropyl group, a cyclobutyl group, a cyclopentyl group, a cyclohexyl group, a cycloheptyl group, a cyclooctyl group, a cyclononyl group, a cyclodecyl group, a cycloundecyl group, cyclododecyl group, a cyclotridecyl group, a cyclotetradecyl group, a cyclopentadecyl group, a cyclohexadecyl group, a cycloheptadecyl group, a cyclooctadecyl group, a cyclononadecyl group, and a cycloicosyl group.

Specific examples of the cycloalkylalkyl group include a cyclopropylmethyl group, a cyclobutylmethyl group, a cyclopentylmethyl group, a cyclohexylmethyl group, a cycloheptylmethyl group, a cyclooctylmethyl group, a cyclononylmethyl group, a cyclodecylmethyl group, a cycloundecylmethyl group, a cyclododecylmethyl group, a cyclotridecylmethyl group, a cyclotetradecylmethyl group, a cyclopentadecylmethyl group, a cyclohexadecylmethyl group, a cycloheptadecylmethyl group, a cyclooctadecylmethyl group, a cyclononadecylmethyl group, a 2-cyclopropylethyl group, a 2-cyclobutylethyl group, a 2-cyclopentylethyl group, a 2-cyclohexylethyl group, a 2-cycloheptylethyl group, a 2-cyclooctylethyl group, a 2-cyclononylethyl group, a 2-cyclodecylethyl group, a 2-cycloundecylethyl group, a 2-cyclododecylethyl group, a 2-cyclotridecylethyl group, a 2-cyclotetradecylethyl group, a 2-cyclopentadecylethyl group, a 2-cyclohexadecylethyl group, a 2-cycloheptadecylethyl group, a 2-cyclooctadecylethyl group, a 3-cyclopropylpropyl group, a 3-cyclobutylpropyl group, a 3-cyclopentylpropyl group, a 3-cyclohexylpropyl group, a 3-cycloheptylpropyl group, a 3-cyclooctylpropyl group, a 3-cyclononylpropyl group, a 3-cyclodecylpropyl group, a 3-cycloundecylpropyl group, a 3-cyclododecylpropyl group, a 3-cyclotridecylpropyl group, a 3-cyclotetradecylpropyl group, a 3-cyclopentadecylpropyl group, a 3-cyclohexadecylpropyl group, a 3-cycloheptadecylpropyl group, a 4-cyclopropylbutyl group, a 4-cyclobutylbutyl group, a 4-cyclopentylbutyl group, a 4-cyclohexylbutyl group, a 4-cycloheptylbutyl group, a 4-cyclooctylbutyl group, a 4-cyclononylbutyl group, a 4-cyclodecylbutyl group, a 4-cyclododecylbutyl group, a 4-cyclotridecylbutyl group, a 4-cyclotetradecylbutyl group, a 4-cyclopentadecylbutyl group, and a 4-cyclohexadecylbutyl group.

Specific examples of the aromatic hydrocarbon group include a phenyl group, an o-tolyl group, a m-tolyl group, a p-tolyl group, a 2,3-dimethylphenyl group, a 2,4-dimethylphenyl group, a 2,5-dimethylphenyl group, a 2,6-dimethylphenyl group, a 3,4-dimethylphenyl group, a 3,5-dimethylphenyl group, a 2,3,4-trimethylphenyl group, a 2,3,5-trimethylphenyl group, a 2,3,6-trimethylphenyl group, a 2,4,5-trimethylphenyl group, a 2,4,6-trimethylphenyl group, a 3,4,5-trimethylphenyl group, an o-ethylphenyl group, a m-ethylphenyl group, a p-ethylphenyl group, an o-isopropylphenyl group, a m-isopropylphenyl group, a p-isopropylphenyl group, an o-tert-butylphenyl group, a 2,3-diisopropylphenyl group, a 2,4-diisopropylphenyl group, a 2,5-diisopropylphenyl group, a 2,6-diisopropylphenyl group, a 3,4-diisopropylphenyl group, a 3,5-diisopropylphenyl group, a 2,6-di-tert-butylphenyl group, a 2,6-di-tert-butyl-4-methylphenyl group, an α-naphthyl group, a β-naphthyl group, a biphenyl-4-yl group, a biphenyl-3-yl group, a biphenyl-2-yl group, an anthracen-1-yl group, an anthracen-2-yl group, an anthracen-9-yl group, a phenanthren-1-yl group, a phenanthren-2-yl group, a phenanthren-3-yl group, a phenanthren-4-yl group, a phenanthren-9-yl group, a pyren-1-yl group, a pyren-2-yl group, a pyren-3-yl group, and a pyren-4-yl group.

Specific examples of the aralkyl group include a benzyl group, a phenethyl group, a 1-phenylethyl group, a 3-phenylpropyl group, a 2-phenylpropyl group, a 1-phenylpropyl group, a 2-phenyl-1-methylethyl group, a 1-phenyl-1-methylethyl group (a cumyl group), a 4-phenylbutyl group, a 3-phenylbutyl group, a 2-phenylbutyl group, a 1-phenylbutyl group, a 3-phenyl-2-methylpropyl group, a 3-phenyl-1-methylpropyl group, a 2-phenyl-1-methylpropyl group, a 2-methyl-1-phenylpropyl group, a 2-phenyl-1,1-dimethylethyl group, a 2-phenyl-2,2,-dimethylethyl group, an α-naphthylmethyl group, a β-naphthylmethyl group, a 2-α-naphthylethyl group, a 2-β-naphthylethyl group, a 1-α-naphthylethyl group, and a 1-β-naphthylethyl group.

Among the groups as described above, R¹ and R² are each preferably an alkyl group having 1 to 20 carbon atoms or an aromatic hydrocarbon group having 6 to 20 carbon atoms, more preferably an alkyl group having 1 to 10 carbon atoms or an aromatic hydrocarbon group having 6 to 10 carbon atoms, even more preferably an alkyl group having 1 to 6 carbon atoms and a phenyl group, and particularly preferably an alkyl group having 1 to 4 carbon atoms.

R³ is preferably an alkyl group having 1 to 20 carbon atoms, a cycloalkyl group having 3 to 20 carbon atoms, an aromatic hydrocarbon group having 6 to 20 carbon atoms, or an aralkyl group having 7 to 20 carbon atoms.

R⁴ is preferably an alkyl group having 1 to 20 carbon atoms, an alkenyl group having 2 to 20 carbon atoms, a cycloalkyl group having 3 to 20 carbon atoms, an aromatic hydrocarbon group having 6 to 20 carbon atoms, or an aralkyl group having 7 to 20 carbon atoms.

In the formula (1) , R⁵ and R⁶ each independently represent an organic substituent having 1 to 20 carbon atoms and optionally having at least one hetero atom, or an inorganic substituent, and m and n are each independently an integer of 0 to 4. If a plurality of R⁵s and a plurality of R⁶s are present, the plurality of R⁵s and the plurality of R⁶s are each optionally a different group.

There is no particular limitation for the organic substituent as long as it is an organic group known to be able to be substituted on a conventional aromatic ring, and does not interfere with a reaction for generating a catalyst represented by the above formula (1). Examples of such an organic group include a hydrocarbon group having 1 to 20 carbon atoms and optionally having at least one hetero atom, which does not interfere with a reaction for generating a catalyst represented by the above formula (1).

In a case where the hydrocarbon group includes at least one hetero atom, there is no particular limitation for the type of the at least one hetero atom as long as the object of the present invention can be achieved. Specific examples of the at least one hetero atom include an oxygen atom, a nitrogen atom, a sulfur atom, a phosphorus atom, a silicon atom, a selenium atom, a halogen atom, and the like.

In a case where the hydrocarbon group includes at least one hetero atom, there is no particular limitation for the number of hetero atoms. In a case where the hydrocarbon group includes at least one hetero atom, the total of the number of carbon atoms and the number of hetero atoms is preferably 30 or less, more preferably 25 or less, and in particular preferably 20 or less. In a case where the hydrocarbon group includes at least one hetero atom, the number of hetero atoms is preferably 10 or less, more preferably 5 or less, and particularly preferably 3 or less. Examples of a hetero atom-involving bond optionally included in the hydrocarbon group include the bonds described above for R¹ to R⁴.

Examples of the organic substituent include, for example, an alkyl group having 1 to 20 carbon atoms, an alkoxy group having 1 to 20 carbon atoms, a cycloalkyl group having 3 to 20 carbon atoms, an aliphatic acyl group having 2 to 20 carbon atoms, a benzoyl group, an α-naphthylcarbonyl group, a β-naphthylcarbonyl group, an aromatic hydrocarbon group having 6 to 20 carbon atoms, and an aralkyl group having 7 to 20 carbon atoms. Among these organic substituents, preferred are an alkyl group having 1 to 6 carbon atoms, an alkoxy group having 1 to 6 carbon atoms, a cycloalkyl group having 3 to 8 carbon atoms, an aliphatic acyl group having 2 to 6 carbon atoms, a benzoyl group, a phenyl group, a benzyl group, and a phenethyl group. Among the organic substituents, more preferred are a methyl group, an ethyl group, an n-propyl group, an isopropyl group, an n-butyl group, an isobutyl group, a sec-butyl group, a tert-butyl group, a methoxy group, an ethoxy group, an n-propyloxy group, an isopropyloxy group, an n-butyloxy group, an isobutyloxy group, a sec-butyloxy group, a tert-butyloxy group, an acetyl group, a propionyl group, a butanoyl group, and a phenyl group.

There is no particular limitation for the inorganic substituent as long as it is an inorganic group known to be able to be substituted on a conventional aromatic ring, and does not interfere with a reaction for generating a catalyst represented by the above formula (1). Examples of the inorganic group include a halogen atom, a nitro group, a cyano group, and the like.

In a case where two groups of the plurality of R⁵s or two groups of the plurality of R⁶s are attached to respective positions adjacent to each other on the aromatic ring, the two groups are optionally joined together to form a ring. Such a ring represents a fused ring which is fused with the aromatic ring included in the fluorene skeleton in the formula (1). The fused ring may be an aromatic ring or an aliphatic ring, but is preferably an aliphatic ring. The fused ring may have a hetero atom on the ring such as an oxygen atom, a nitrogen atom, and a sulfur atom.

Specific examples of a fluorene skeleton having a fused ring formed with two R⁵s and/or two R⁶s include a skeleton represented by the following formula:

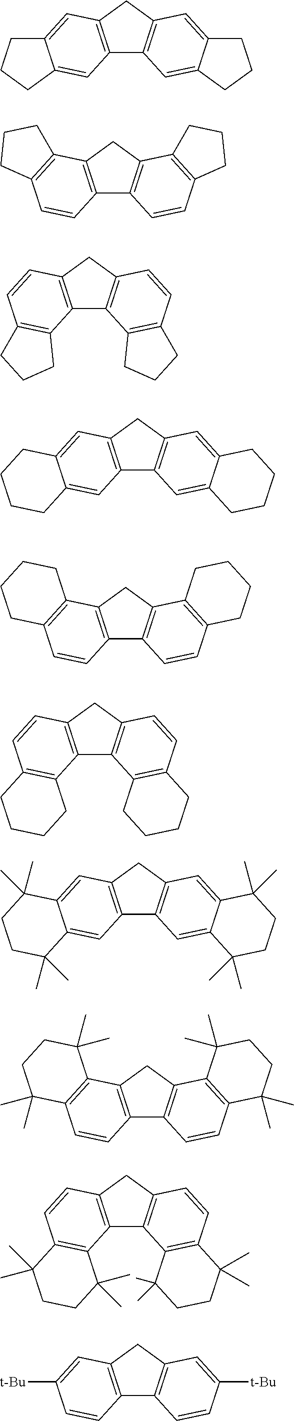

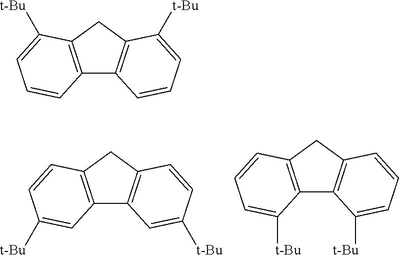

In the formula (1), M is Ti, Zr, or Hf, and is preferably Ti.

Suitable Examples of the catalyst represented by the formula (1) as described above include a catalyst having the following structure:

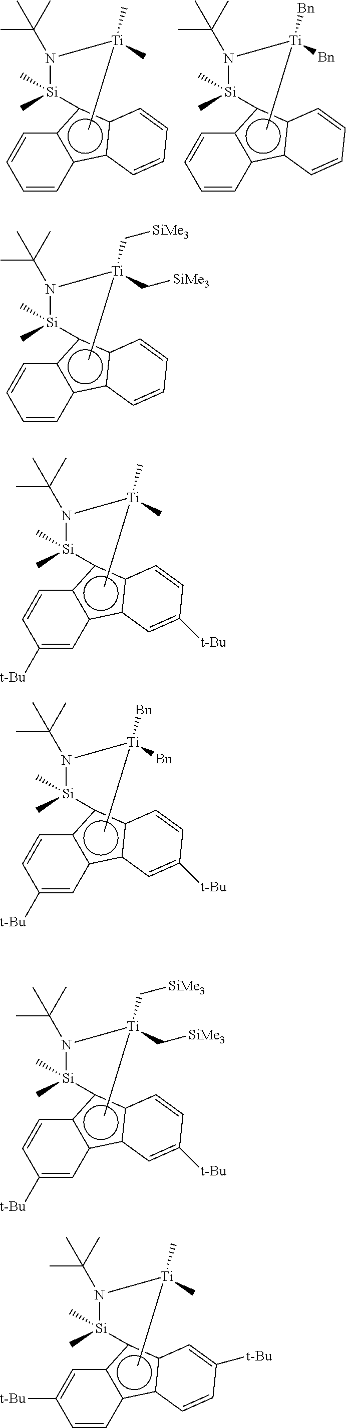

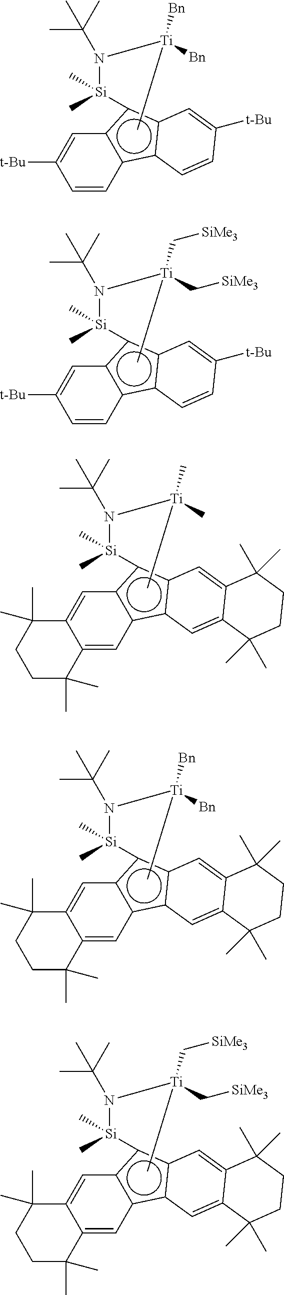

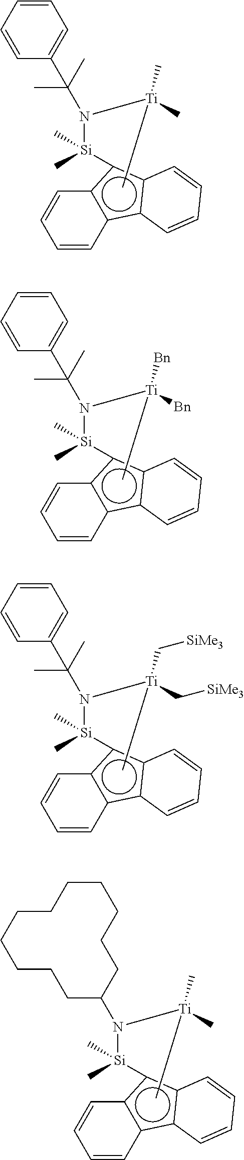

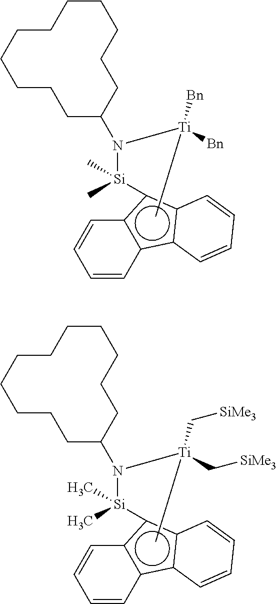

### Step (I)

In order to manufacture a catalyst represented by the formula (1), first, in step (I), a ligand represented by the following formula (1a):

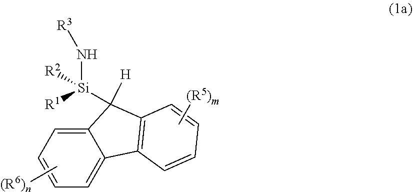

wherein in the formula (1a) , R¹, R², R³, R⁵, R⁶, m, and n are as defined in the above,
is allowed to react with a compound represented by the following formula (1b):

LiR⁷ (1b)

wherein in the formula (1b), R⁷ represents a hydrocarbon group having 1 to 20 carbon atoms and optionally having at least one hetero atom, and is attached to the lithium atom via a C—Li bond.

A reaction which proceeds in step (I) will yield an intermediate represented by the following formula (1g):

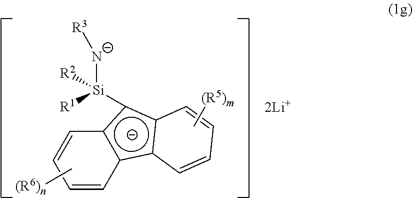

wherein in the formula (1g) , R¹, R², R³, R⁵, R⁶, m, and n are as defined in the above.

The structure of a ligand represented by the formula (1a) is appropriately selected depending on the structure of a catalyst to be manufactured. Among the ligands represented by the formula (1a), a ligand represented by the following formula (1a-1) is preferred in view of good reactivity, easy synthesis and availability, and low cost.

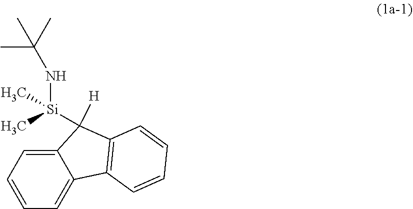

In step (I), the lithium compound represented by the formula (1b) in an amount of 2.0 molar equivalents or more relative to the ligand represented by a formula (1a) is allowed to react if the R⁴ group of a Mg compound represented by the formula (1c), a Zn compound represented by the formula (1d), or an Al compound represented by the formula (1e), which are used in step (II) as described below, is identical to R⁷ of the organic lithium compound. Alternatively, the organic lithium compound represented by the formula (1b) in an amount of 1.8 molar equivalents or more and 2.2 molar equivalents or less relative to the ligand represented by the formula (1a) is allowed to react if the R⁴ group of the Mg compound represented by the formula (1c), the Zn compound represented by the formula (1d), or the Al compound represented by the formula (1e), which are used in step (II) as described below, is not identical to R⁷ of the organic lithium compound. A reaction of the organic organolithium compound in an amount within these ranges with the ligand represented by the formula (1a) eventually enables manufacture of a highly pure catalyst in a high yield.

Preferably, the lower limit of the usage amount of the compound represented by the formula (1b) in step (I) is preferably, for example, 2 molar equivalents if the R⁴ group of the Mg compound represented by the formula (1c), the Zn compound represented by the formula (1d), or the Al compound represented by the formula (1e), which are used in step (II) as described below, is identical to R⁷ of the organic lithium compound. The usage amount of the compound represented by the formula (1b) in step (I) is more preferably 1.9 molar equivalents or more and 2.1 molar equivalents or less if the R⁴ group of the Mg compound represented by the formula (1c), the Zn compound represented by the formula (1d), or the Al compound represented by the formula (1e), which are used in step (II) as described below, is not identical to R⁷ of the organic lithium compound.

In the organolithium compound represented by the formula (1b), R⁷ is similarly defined as in R¹, R², R³, and R⁴. However, R⁷ is attached to the lithium atom via a C—Li bond. R⁷ is preferably an alkyl group having 1 to 20 carbon atoms, a trialkylsilylalkyl group having 4 to 20 carbon atoms, an alkenyl group having 2 to 20 carbon atoms, a cycloalkyl group having 3 to 20 carbon atoms, an aromatic hydrocarbon group having 6 to 20 carbon atoms, and an aralkyl group having 7 to 20 carbon atoms.

Suitable and specific examples of the organolithium compound represented by the formula (1b) include methyllithium, ethyllithium, n-propyllithium, isopropyllithium, n-butyllithium, isobutyllithium, sec-butyllithium, tert-butyllithium, n-pentyl lithium, n-hexyllithium, trimethylsilylmethyllithium, phenyllithium, p-tolyllithium, m-tolyllithium, o-tolyllithium, benzyllithium, vinyllithium, allyllithium, and the like.

In step (I), a solvent is usually used. There is no particular limitation for the type of the solvent as long as the object of the present invention can be achieved. Typically, an aprotic solvent is used. There is no particular limitation for the type of the aprotic solvent as long as the object of the present invention can be achieved. The aprotic solvent may be a polar or nonpolar solvent. Preferred aprotic solvents include an ether-based solvent and a hydrocarbon-based solvent. Suitable and specific examples of the aprotic solvent include ether-based solvents such as diethyl ether, di-n-propyl ether, diisopropyl ether, di-n-butyl ether, tetrahydrofuran, and dioxane; aliphatic hydrocarbon solvents such as pentane, hexane, heptane, and octane; and aromatic hydrocarbon solvents such as benzene, toluene, and xylene. In particular, an aprotic solvent containing diethyl ether is preferably used. Diethyl ether may be used in combination with an ether-based solvent other than diethyl ether, or in combination with an aliphatic hydrocarbon solvent, or in combination with an aromatic hydrocarbon solvent. An aprotic solvent other than diethyl ether may also be used as long as it allows the desired reaction to proceed favorably. A solvent mixture may also be used. In that case, the solvent mixture may be any of a mixture of an ether-based solvent other than diethyl ether and an aliphatic hydrocarbon solvent; a mixture of an ether-based solvent other than diethyl ether and an aromatic hydrocarbon solvent; and a mixture of an aliphatic hydrocarbon solvent and an aromatic hydrocarbon solvent.

There is no particular limitation for the amount of a solvent to be used as long as the object of the present invention can be achieved. Typically, the amount of a solvent to be used is preferably such that the molarity of a ligand is 0.001 to 2 mol/L, more preferably 0.01 to 1 mol/L, and particularly preferably 0.05 to 0.5 mol/L.

There is no particular limitation for a temperature at which the ligand represented by the formula (1a) is allowed to react with the organolithium compound represented by the formula (1b) as long as the object of the present invention can be achieved. Typically, it is preferably −78 to 60° C., more preferably 0 to 50° C., and particularly preferably 10 to 40° C. The reaction temperature may be higher than the boiling point of a solvent. In a case where the reaction temperature is higher than the boiling point of a solvent, the reaction may be performed in a sealable pressure vessel.

There is no particular limitation for an atmosphere under which the ligand represented by the formula (1a) is reacted with the organolithium compound represented by the formula (1b). An inert gas atmosphere is preferably used in view of a tendency of reduced side reactions. Inert gases include nitrogen, argon, and the like.

There is no particular limitation for a reaction time for allowing the ligand represented by the formula (1a) to react with the organolithium compound represented by the formula (1b) in step (I). The reaction time in step (I) may vary depending on the usage amount of the organolithium compound represented by the formula (1b), the amount of a solvent to be used, the reaction temperature, and the like. The reaction time is typically 1 to 24 hours, and preferably 2 to 4 hours.

A reaction product of the ligand represented by the formula (1a) and the organolithium compound represented by the formula (1b) obtained by performing the method described above will be subjected to step (II). It is noted that the reaction product may be subjected to step (II) as a reaction liquid of step (I). The reaction liquid may be concentrated or diluted before subjected to step (II), if needed. In a case where the reaction liquid of step (I) is used in step (II), steps (I) and (II) may be performed in the same vessel without transferring the reaction liquid of step (I) to another reaction vessel. Alternatively, a reagent required for step (II) may be charged into a separate vessel different from one used in step (I), and the reaction liquid of step (I) may be added to the separate vessel to perform step (II).

### Step (II)

In step (II), the product from step (I) is allowed to react with one or more selected from the group consisting of a compound represented by the following formula (1c), a compound represented by the following formula (1d), and a compound represented by the following (1e):

(R⁴)ₚMgX₍₂₋ₚ₎ (1c)

(R⁴)_{q}ZnX_{(2-q)} (1d)

(R⁴)ᵣAlX₍₃₋ᵣ₎ (1e)

wherein in the formulae (1c), (1d), and (1e), R⁴ is as defined in the above; X is a halogen atom; p is 1 or 2; q is 1 or 2; and r is an integer of 1 to 3.

In step (II), a compound selected from the group consisting of the Mg compound represented by the formula (1c), the Zn compound represented by the formula (1d), and the Al compound represented by the formula (1e) may be used in an amount such that the number of moles of the R⁴ group in each of these compounds is larger by 2 times or more than that of the ligand. Use of the Mg compound, the Zn compound, and the Al compound in an amount within the above range enables production of a highly pure catalyst in a good yield. The usage amounts of the Mg compound, the Zn compound, and the Al compound are such that the number of moles of the R⁴ group in each of these compounds is preferably larger by 2 times or more than that of the ligand, more preferably by 2.2 times or more, and particularly preferably by 2.5 times or more. The usage amounts of the Mg compound, the Zn compound, and the Al compound are such that the number of moles of the R⁴ group in each of these compounds is preferably larger by 4.5 times or less than that of the ligand, more preferably by 4 times or less, and particularly preferably 3.5 times or less.

Among the Mg compound represented by the formula (1c), the Zn compounds represented by the formula (1d), and the Al compound represented by the formula (1e), the Mg compound represented by the formula (1c) is preferred because it can readily be available or synthesized, and can allow the desired reaction to proceed favorably.

For R⁴ of the Mg compound represented by the formula (1c), the Zn compound represented by the formula (1d), or the Al compound represented by the formula (1e), preferred are an alkyl group having 1 to 20 carbon atoms, an alkenyl group having 2 to 20 carbon atoms, a cycloalkyl group having 3 to 20 carbon atoms, an aromatic hydrocarbon group having 6 to 20 carbon atoms, and an aralkyl group having 7 to 20 carbon atoms.

Suitable and specific examples of the Mg compound represented by the formula (1c) include methylmagnesium bromide, ethylmagnesium bromide, isopropylmagnesium bromide, n-butylmagnesium bromide, isobutylmagnesium bromide, sec-butylmagnesium bromide, tert-butylmagnesium bromide, n-pentylmagnesium bromide, n-hexylmagnesium bromide, trimethylsilylmethylmagnesium bromide, phenylmagnesium bromide, p-tolylmagnesium bromide, m-tolylmagnesium bromide, o-tolylmagnesium bromide, benzylmagnesium bromide, vinylmagnesium bromide, allylmagnesium bromide, methylmagnesium chloride, ethylmagnesium chloride, isopropylmagnesium chloride, n-butylmagnesium chloride, isobutylmagnesium chloride, sec-butylmagnesium chloride, tert-butylmagnesium chloride, n-pentylmagnesium chloride, n-hexylmagnesium chloride, trimethylsilylmethylmagnesium chloride, phenylmagnesium chloride, p-tolylmagnesium chloride, m-tolylmagnesium chloride, o-tolylmagnesium chloride, benzylmagnesium chloride, vinylmagnesium chloride, allylmagnesium chloride, methylmagnesium iodide, ethylmagnesium iodide, isopropylmagnesium iodide, n-butylmagnesium iodide, isobutylmagnesium iodide, butylmagnesium iodide, tert-butylmagnesium iodide, n-sec-pentylmagnesium iodide, n-hexylmagnesium iodide, trimethylsilylmethylmagnesium iodide, phenylmagnesium iodide, p-tolylmagnesium iodide, m-tolylmagnesium iodide, o-tolylmagnesium iodide, benzylmagnesium iodide, vinylmagnesium iodide, allylmagnesium iodide, dimethylmagnesium, diethylmagnesium, diisopropylmagnesium, di-n-butylmagnesium, diisobutylmagnesium, di-sec-butylmagnesium, di-tert-butylmagnesium, di-n-pentylmagnesium, di-n-hexylmagnesium, bis(trimethylsilylmethyl)magnesium, diphenylmagnesium, di-p-tolylmagnesium, di-m-tolylmagnesium, di-o-tolylmagnesium, dibenzylmagnesium, divinylmagnesium, diallylmagnesium, and the like.

Suitable and specific examples of the Zn compound represented by the formula (1d) include methylzinc bromide, ethylzinc bromide, isopropylzinc bromide, n-butylzinc bromide, isobutylzinc bromide, sec-butylzinc bromide, tert-butylzinc bromide, n-pentylzinc bromide, n-hexylzinc bromide, trimethylsilylmethylzinc bromide, phenylzinc bromide, p-tolylzinc bromide, m-tolylzinc bromide, o-tolylzinc bromide, benzylzinc bromide, vinylzinc bromide, allylzinc bromide, methylzinc chloride, ethylzinc chloride, isopropylzinc chloride, n-butylzinc chloride, isobutylzinc chloride, sec-butylzinc chloride, tert-butylzinc chloride, n-pentylzinc chloride, n-hexylzinc chloride, trimethylsilylmethylzinc chloride, phenylzinc chloride, p-tolylzinc chloride, m-tolylzinc chloride, o-tolylzinc chloride, benzylzinc chloride, vinylzinc chloride, allylzinc chloride, methylzinc iodide, ethylzinc iodide, isopropylzinc iodide, n-butylzinc iodide, isobutylzinc iodide, sec-butylzinc iodide, tert-butylzinc iodide, n-pentylzinc iodide, n-hexylzinc iodide, trimethylsilylmethylzinc iodide, phenylzinc iodide, p-tolylzinc iodide, m-tolylzinc iodide, o-tolylzinc iodide, benzylzinc iodide, vinylzinc iodide, allylzinc iodide, dimethylzinc, diethylzinc, diisopropylzinc, di-n-butylzinc, diisobutylzinc, di-sec-butylzinc, di-tert-butylzinc, di-n-pentylzinc, di-n-hexylzinc, bis(trimethylsilylmethyl)zinc, diphenylzinc, di-p-tolylzinc, di-m-tolylzinc, di-o-tolylzinc, dibenzylzinc, divinylzinc, diallylzinc, and the like.

Suitable and specific examples of the Al compound represented by the formula (1e) include methylaluminum dibromide, ethylaluminum dibromide, isopropylaluminum dibromide, n-butylaluminum dibromide, isobutylaluminum dibromide, sec-butylaluminum dibromide, tert-butylaluminum dibromide, n-pentylaluminum dibromide, n-hexylaluminum dibromide, trimethylsilylmethylaluminum dibromide, phenylaluminum dibromide, p-tolylaluminum dibromide, m-tolylaluminum dibromide, o-tolylaluminum dibromide, benzylaluminum dibromide, vinylaluminum dibromide, allylaluminum dibromide, methylaluminum dichloride, ethylaluminum dichloride, isopropylaluminum dichloride, n-butylaluminum dichloride, isobutylaluminum dichloride, sec-butylaluminum dichloride, tert-butylaluminum dichloride, n-pentylaluminum dichloride, n-hexylaluminum dichloride, trimethylsilylmethylaluminum dichloride, phenylaluminum dichloride, p-tolylaluminum dichloride, m-tolylaluminum dichloride, o-tolylaluminum dichloride, benzylaluminum dichloride, vinylaluminum dichloride, allylaluminum dichloride, methylaluminum diiodide, ethylaluminum diiodide, isopropylaluminum diiodide, n-butylaluminum diiodide, isobutylaluminum diiodide, sec-butylaluminum diiodide, tert-butylaluminum diiodide, n-pentylaluminum diiodide, n-hexylaluminum diiodide, trimethylsilylmethylaluminum diiodide, phenylaluminum diiodide, p-tolylaluminum diiodide, m-tolylaluminum diiodide, o-tolylaluminum diiodide, benzylaluminum diiodide, vinylaluminum diiodide, allylaluminum diiodide, dimethylaluminum bromide, diethylaluminum bromide, diisopropylaluminum bromide, di-n-butylaluminum bromide, diisobutylaluminum bromide, di-sec-butylaluminum bromide, di-tert-butylaluminum bromide, di-n-pentylaluminum bromide, di-n-hexylaluminum bromide, bis(trimethylsilylmethyl)aluminum bromide, diphenylaluminum bromide, di-p-tolylaluminum bromide, di-m-tolylaluminum bromide, di-o-tolylaluminum bromide, dibenzylaluminum bromide, divinylaluminum bromide, diallylaluminum bromide, dimethylaluminum chloride, diethylaluminum chloride, diisopropylaluminum chloride, di-n-butylaluminum chloride, diisobutylaluminum chloride, di-sec-butylaluminum chloride, di-tert-butylaluminum chloride, di-n-pentylaluminum chloride, di-n-hexylaluminum chloride, bis(trimethylsilylmethyl)aluminum chloride, diphenylaluminum chloride, di-p-tolylaluminum chloride, di-m-tolylaluminum chloride, di-o-tolylaluminum chloride, dibenzylaluminum chloride, divinylaluminum chloride, diallylaluminum chloride, dimethylaluminum iodide, diethylaluminum iodide, diisopropylaluminum iodide, di-n-butylaluminum iodide, diisobutylaluminum iodide, di-sec-butylaluminum iodide, di-tert-butylaluminum iodide, di-n-pentylaluminum iodide, di-n-hexylaluminum iodide, bis(trimethylsilylmethyl)aluminum iodide, diphenylaluminum iodide, di-p-tolylaluminum iodide, di-m-tolylaluminum iodide, di-o-tolylaluminum iodide, dibenzylaluminum iodide, divinylaluminum iodide, diallylaluminum iodide, trimethylaluminum, triethylaluminum, triisopropylaluminum, tri-n-butylaluminum, triisobutylaluminum, tri-sec-butylaluminum, tri-tert-butylaluminum, tri-n-pentylaluminum, tri-n-hexylaluminum, tris(trimethylsilylmethyl)aluminum, triphenylaluminum, tri-p-tolylaluminum, tri-m-tolylaluminum, tri-o-tolylaluminum, tribenzyaluminum, trivinylaluminum, triallylaluminum, and the like.

With regard to a solvent used in step (II), the type of a suitable solvent and the suitable range of the usage amount are similar to these in step (I).

There is no particular limitation for the reaction temperature in step (II) as long as the object of the present invention can be achieved. Typically, it is preferably 60° C. or less. The reaction temperature may be higher than the boiling point of a solvent. In a case where the reaction temperature is higher than the boiling point of a solvent, the reaction may be performed in a sealable pressure vessel.

There is no particular limitation for an atmosphere under which the reaction is performed in step (II). An inert gas atmosphere is preferably used in view of a tendency of reduced side reactions. Inert gases include nitrogen, argon, and the like.

There is no particular limitation for the reaction time in step (II) as long as a catalyst can be manufactured in the desired purity and yield. There is no particular limitation for the reaction temperature in step (II) as long as the object of the present invention can be achieved. The reaction time may vary depending on the usage amounts of the Mg compound, the Zn compound, and the Al compound; the amount of a solvent to be used; the reaction temperature; and the like. Typically, the reaction time may be as short as 15 minutes or less or 20 minutes or less. Alternatively, the reaction time in step (II) may be prolonged. It is preferably 24 hours or less in view of the efficiency of manufacture.

The reaction product obtained as described above in step (II) will be subjected to step (III). It is noted that the reaction product may be subjected to step (III) as a reaction liquid of step (II). The reaction liquid may be concentrated or diluted before being subjected to step (III), if needed. In a case where the reaction liquid of step (II) is used in step (III), steps (II) and (III) may be performed in the same vessel without transferring the reaction liquid of step (II) to another reaction vessel. Alternatively, a reagent required for step (III) may be charged into a separate vessel different from one used in step (II), and the reaction liquid of step (II) may be added to the separate vessel to perform step (III).

### Step (III)

In step (III), the product obtained from step (II) is allowed to react with a compound represented by the following formula (1f) in an amount of 1 molar equivalent or more relative to the aforementioned ligand:

MR⁸₄ (1f)

wherein in the formula (1f), M is as defined in the above; R⁸ represents a halogen atom or a group represented by —OR⁹; R⁹ represents a hydrocarbon group having 1 to 20 carbon atoms and optionally having at least one hetero atom; and R⁹ is attached to the oxygen atom via a C—O bond.

In step (III), the intermediate represented by the aforementioned formula (1g) included in the product from step (II) and a compound selected from the group consisting of the Mg compound represented by the formula (1c), the Zn compound represented by the formula (1d), and the Al compound represented by (1e) are allowed to react with the compound represented by the aforementioned formula (1f) to form a catalyst having the structure represented by the formula (1).

In a case where R⁸ in the compound represented by the formula (1f) is a halogen atom, there is no particular limitation for the halogen atom as long as the desired reaction proceeds. The halogen atom is preferably a chlorine atom or a bromine atom. In a case where R⁸ is —OR⁹, R⁹ is a hydrocarbon group having 1 to 20 carbon atoms and optionally having at least one hetero atom, and is attached to the oxygen atom via a C—O bond. The hydrocarbon group having 1 to 20 carbon atoms and optionally having at least one hetero atom is as defined for R¹ to R⁴ in the formula (1) except for the restriction that it is attached to the oxygen atom via a C—O bond. R⁹ is preferably a hydrocarbon group having no hetero atoms, and preferably an alkyl group, an aralkyl group, or an aromatic hydrocarbon group. Preferred and specific examples of —OR⁹ include a methoxy group, an ethoxy group, an n-propyloxy group, an isopropyloxy group, an n-butyloxy group, an isobutyloxy group, a sec-butyloxy group, a tert-butyloxy group, a phenoxy group, and a benzyloxy group.

Suitable and specific examples of the compound represented by the formula (1f) include TiCl₄, ZrCl₄, HfCl₄, TiBr₄, ZrBr₄, HfBr₄, Ti(OMe)₄, Zr(OMe)₄, Hf(OMe)₄, Ti(OEt)₄, Zr(OEt)₄, Hf(OEt)₄, Ti(O-n-Pr)₄, Zr(O-n-Pr)₄, Hf(O-n-Pr)₄, Ti(O-i-Pr)₄, Zr(O-i-Pr)₄, Hf(O-i-Pr)₄, Ti(OPh)₄, Zr(OPh)₄, Hf(OPh)₄, Ti(O-n-Bu)₄, Zr(O-n-Bu)₄, Hf(O-n-Bu)₄, Ti(OBn)₄, Zr(OBn)₄, and Hf(OBn)₄. Among these, TiCl₄, ZrCl₄, HfCl₄, TiBr₄, ZrBr₄, and HfBr₄ are preferred, and TiCl₄, ZrCl₄, and HfCl₄ are more preferred, and TiCl₄ is particularly preferred in view of easy availability and good reactivity.

The compound represented by the formula (1f) is used in an amount of 1 molar equivalent or more relative to the ligand used in step (I). Use of the compound represented by the formula (1f) in an amount within the above range can reduce side reactions, leading to a catalyst as the final product which has an excellent purity and yield. The compound represented by the formula (1f) may be used as it is, or may be used in a state where it is dissolved or suspended in a solvent. The compound represented by the formula (1f) is preferably used in the form of a solution because side reactions in step (III) tend to be reduced. There is no particular limitation for the type of a solvent for diluting the formula (1f). The solvent is preferably an aprotic solvent. The solvents described in step (I) may be preferably used as an aprotic solvent. There is no particular limitation for the upper limit of the usage amount of the compound represented by the formula (1f) as long as the object of the present invention can be achieved. The upper limit of the usage amount of the compound represented by the formula (1f) is preferably 1.5 molar equivalents, more preferably 1.25 molar equivalents, and in particular preferably 1 molar equivalent. Even if more than 1.5 molar equivalents of the compound represented by the formula (1f) is used, a catalyst can be manufactured. However, this does not necessarily provide effects for improving the yield and/or purity of a catalyst, which is commensurate with the increased cost, and rather may result in somewhat complicated purification of the catalyst. Therefore, use of the compound represented by the formula (1f) in an amount of more than 1.5 molar equivalents cannot be rationalized.

The type and preferred range of the usage amount of a solvent in step (III) are as defined in step (I).

There is no particular limitation for the temperature at which the reaction is performed in step (III) as long as the object of the present invention can be achieved. Typically, it is preferably −78 to 60° C. The reaction temperature may be higher than the boiling point of a solvent. In a case where the reaction temperature is higher than the boiling point of a solvent, the reaction may be performed in a sealable pressure vessel.

There is no particular limitation for an atmosphere under which the reaction in step (III) is performed. An inert gas atmosphere is preferably used in view of a tendency of reduced side reactions. Inert gases include nitrogen, argon, and the like.

There is no particular limitation for a period of time for which the reaction is performed in step (III). The reaction time in step (III) is typically 1 to 24 hours. Preferably, the reaction time is not too long in order to prevent degradation of a product.

A catalyst having the structure represented by the formula (1) manufactured according to the method described above which includes steps (I), (II), and (III) may be purified, separated, or recovered from a reaction liquid, if needed, and then used as a catalyst for polymerization reactions. A catalyst produced through steps (I), (II), and (III) usually contains impurities such as salts. Therefore, it is preferably purified through an additional step as described below, and then used for polymerization reactions.

### Additional Steps

In addition to steps (I), (II), and (III), a catalyst synthesized may be recovered from a reaction liquid of step (III) by further performing an additional step.

For example, after a catalyst is extracted with an organic solvent from a residue obtained by concentrating a reaction liquid of step (III), insoluble byproducts in the residue are separated from an extract containing insoluble materials by a method such as filtration. Subsequently, the catalyst is precipitated from the extract containing the catalyst to obtain a purified catalyst. The above operation of removing insoluble impurities may be performed repeatedly.

The reaction liquid obtained in step (III) as described above may be concentrated to obtain crude crystals of the catalyst. The crude crystals of the catalyst obtained in this way may be used directly in polymerization reactions. A catalyst purified to the desired purity is preferably used in polymerization reactions. There is no particular limitation for a method of purifying a catalyst to the desired purity. Typically, recrystallization with an organic solvent is preferred. A solvent which can be used in steps (I) to (III) may be used as a recrystallization solvent. There is no particular limitation for a method of precipitating crystals during recrystallization, but examples include cooling, concentration, and the like. After recrystallization, precipitated crystals may be recovered by a method such as filtration and decantation to obtain a purified catalyst.

The yield of a catalyst obtained through the above steps is preferably 40% or more, more preferably 45% or more as determined by the NMR internal standard method (in terms of the ethylbenzene standard). Further, the purity of a catalyst at the end of step (III) is preferably 90% or more, more preferably 95% or more as determined by the NMR internal standard method (in terms of the ethylbenzene standard). It is noted that a purity as determined by the NMR internal standard method in nature may be determined to be more than 100%.

### EXAMPLES

Below, the present invention will be described in more detail with reference to Examples, but the present invention shall not be limited to these.

### Example 1

### Step (I)

Within a glove box having an atmosphere replaced with dry nitrogen, 50 mL of diethyl ether and 1.56 g (5.28 mmol) of a ligand having the following structure were added to a Schlenk flask. After dissolving the ligand in diethyl ether, 10.1 mL of a solution of methyllithium in diethyl ether (1.06 M, the content of methyllithium: 10.7 mmol (2.0 molar equivalents (relative to the ligand))) was added to the Schlenk flask. Then, the ligand was allowed to react with methyllithium at room temperature for 2.5 hours.

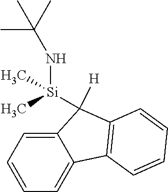

### Step (II)

To the reaction liquid obtained from step (I), added dropwise was 5.3 mL of a solution of CH₃MgBr in diethyl ether (3.0 M, the content of CH₃MgBr: 15.9 mmol (3.0 molar equivalents (relative to the ligand))). The liquid after the completion of dropwise addition was obtained as a reaction liquid of step (II).

### Step (III)

Into a two-necked flask, charged were 0.58 mL (5.29 mmol) of TiCl₄ and 50 mL of hexane. After the reaction liquid of step (II) was added dropwise to the solution of TiCl₄ in the flask, the content of the flask was stirred at room temperature for 15 hours. In this way, a black reaction liquid including a catalyst having the following structure was obtained.

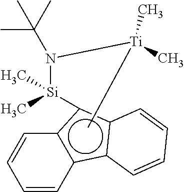

### Additional Steps

The solvent was distilled away from the content of the flask under reduced pressure to obtain a residue as a black powder. The resulting black powder was suspended in 40 mL of hexane, allowing the catalyst to be extracted into hexane. The suspension was passed through a glass filter to remove insoluble components. The insoluble components removed from the suspension were further subjected to a similar extraction operation once with 40 mL of hexane, and twice with 20 mL of hexane. The resulting filtrate (catalyst extract) was dried under reduced pressure to obtain 1.44 g of a catalyst. The yield of the resulting catalyst relative to the usage amount of the ligand was 70% as determined by the NMR internal standard method (in terms of the ethylbenzene standard), and the purity of the catalyst was 95% similarly as determined by the NMR internal standard method (in terms of the ethylbenzene standard).

It is noted that the NMR analysis was performed in heavy toluene by ¹H-NMR using a Bruker spectrometer AVANCE III 400. A J-YOUNG NMR sample tube was used as a sample tube for the measurements. Quantitative NMR analysis was performed using ethylbenzene with a purity of 99% or more as the internal standard substance. The usage amount thereof and the ratio of the integral of a peak from the catalyst at 7.71 ppm (doublet, 2H) to the integral of a peak from ethylbenzene at 2.44 ppm (triplet, 2H) was used for calculation.

### Example 2

A catalyst in a solid state was obtained as in Example 1 except that n-butyllithium (a 1.6 M solution in hexane) was used instead of methyllithium. The yield of the resulting catalyst relative to the usage amount of the ligand was 63% as determined by the NMR internal standard method (in terms of the ethylbenzene standard), and the purity of the catalyst was 98% similarly as determined by the NMR internal standard method (in terms of the ethylbenzene standard).

### Comparative Example 1

Within a glove box having an atmosphere replaced with dry nitrogen, 50 mL of diethyl ether and 1.56 g (5.28 mmol) of the same ligand as Example 1 were added to a Schlenk flask. After dissolving the ligand in diethyl ether, 9.4 mL of a solution of methyllithium in diethyl ether (1.12 M, the content of methyllithium: 10.5 mmol (2.0 molar equivalents (relative to the ligand))) was added to the Schlenk flask. Then, the ligand was allowed to react with methyllithium at room temperature for 2.5 hours to obtain a reaction liquid of the ligand and methyllithium.

To a two-necked flask having an atmosphere replaced with nitrogen, added were 50 mL of hexane and 0.58 mL of TiCl₄ (5.29 mmol (1.0 molar equivalent (relative to the ligand))). Subsequently, the reaction liquid of the ligand and methyllithium was added dropwise to the two-necked flask through a cannula. After dropwise addition, the content of the two-necked flask was stirred at room temperature for 17 hours to allow the reaction product of the ligand and methyllithium to react with TiCl₄. The reaction yielded a dark-brown reaction liquid. The solvent was distilled away from the resulting reaction liquid to obtain a black powder as a residue. The resulting black powder was suspended in 20 mL of toluene, allowing the reaction product to be extracted into toluene. The suspension was passed through a glass filter to remove insoluble components. The insoluble components removed from the suspension were further subjected to a similar extraction operation repeated for 3 times with 20 mL of toluene. The resulting filtrate (extract) was dried under reduced pressure to obtain 1.90 g of a reaction product.

The reaction product obtained by using TiCl₄ and 45 mL of toluene were added to a flask to dissolve the reaction product in toluene. Subsequently, 9.4 mL of a solution of methyllithium in diethyl ether (1.12 M, the content of methyllithium: 10.5 mmol (2.0 molar equivalents (relative to the ligand))) was added to the solution of the reaction product, and then the reaction product was allowed to react with methyllithium at room temperature for 12 hours to produce a catalyst.

To the reaction liquid containing the catalyst in the flask, added was 3 mL of a solution of CH₃MgBr in diethyl ether (concentration: 3M, 9 mmol). Subsequently, the content of the flask was stirred at room temperature for 1 hour. The solvent was distilled away from the content of the flask under reduced pressure to obtain a residue as a black powder. The resulting black powder was suspended in 40 mL of hexane, allowing a catalyst to be extracted into hexane. The suspension was passed through a glass filter to remove insoluble components. The insoluble components removed from the suspension were further subjected to a similar extraction operation once with 40 mL of hexane, and twice with 20 mL of hexane. The resulting filtrate (catalyst extract) was dried under reduced pressure to obtain 933 mg of a catalyst. The yield of the resulting catalyst relative to the usage amount of the ligand was 38% as determined by the NMR internal standard method (in terms of the ethylbenzene standard), and the purity of the catalyst was 81% similarly as determined by the NMR internal standard method (in terms of the ethylbenzene standard).

Comparative Example 1 shows that a catalyst with an excellent purity cannot be obtained in a high yield in a case where the amount of methyllithium which is first reacted with a ligand is 2.0 molar equivalents relative to the ligand even when a total of 4.0 molar equivalents of methyllithium relative to the ligand is allowed to react.

### Comparative Example 2

A reaction liquid of the ligand and methyllithium was obtained as in Comparative Example 1 except that the usage amount of methyllithium was changed to 28.0 mmol (5.3 molar equivalents (relative to the ligand)).

To a two-necked flask having an atmosphere replaced with nitrogen, added were 50 mL of hexane and 0.58 mL of TiCl₄ (5.29 mmol (1.0 molar equivalent (relative to the ligand))). Subsequently, the reaction liquid of the ligand and methyllithium was added dropwise to the two-necked flask through a cannula. After dropwise addition, the content of the two-necked flask was stirred at room temperature for 22 hours to allow the reaction product of the ligand and methyllithium to react with TiCl₄. The reaction yielded a dark-brown reaction liquid. The solvent was distilled away from the resulting reaction liquid to obtain a black powder as a residue. The resulting black powder was suspended in 40 mL of hexane, allowing the reaction product to be extracted into hexane. The suspension was passed through a glass filter to remove insoluble components. The insoluble components removed from the suspension were further subjected to a similar extraction operation once with 40 mL of hexane, and twice with 20 mL of hexane. The resulting filtrate (extract) was dried under reduced pressure to obtain a reaction product.

To the resulting reaction product, added was 3 mL of a solution of CH₃MgBr in diethyl ether (concentration: 3M, 9 mmol), and then stirred at room temperature for 5 hours. The solvent was distilled away from the post-stirring solution under reduced pressure to obtain a residue as a black powder. The resulting black powder was suspended in 40 mL of hexane, allowing the catalyst to be extracted into hexane. The suspension was passed through a glass filter to remove insoluble components. The insoluble components removed from the suspension were further subjected to a similar extraction operation once with 40 mL of hexane, and twice with 20 mL of hexane. The resulting filtrate (catalyst extract) was dried under reduced pressure to obtain 958 mg of a catalyst. The yield of the resulting catalyst relative to the usage amount of the ligand was 39% as determined by the NMR internal standard method (in terms of the ethylbenzene standard), and the purity of the catalyst was 80% similarly as determined by the NMR internal standard method (in terms of the ethylbenzene standard). It is noted that Comparative Example 2 corresponds to the method described in Nonpatent Document 2.

Comparative Example 2 shows that a catalyst with an excellent purity cannot be obtained in a high yield even when 5.3 molar equivalents of methyllithium, which is more than the minimum stoichiometric amount of 4.0 molar equivalents relative to the ligand for obtaining a catalyst having the desired structure, is allowed to react, and TiCl₄ is then allowed to react.

1. A method of manufacturing a catalyst represented by the following formula (1): 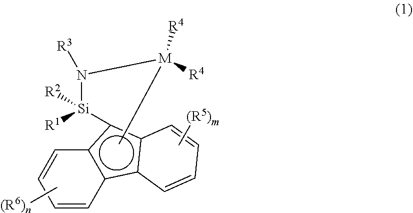
wherein in the formula (1), R¹, R², R³, and R⁴ each independently represent a hydrocarbon group having 1 to 20 carbon atoms and optionally having at least one hetero atom; R¹ and R² are each attached to a silicon atom via a C—Si bond, an O—Si bond, a Si—Si bond, or a N—Si bond; R³ is attached to a nitrogen atom via a C—N bond, an O—N bond, a Si—N bond, or a N—N bond; R⁴ is attached to a metal atom M via a C—M bond; R⁵ and R⁶ each independently represent an organic substituent having 1 to 20 carbon atoms and optionally having at least one hetero atom, or an inorganic substituent; m and n are each independently an integer of 0 to 4; if a plurality of R⁵s and a plurality of R⁶s are present, the plurality of R⁵s and the plurality of R⁶s are each optionally a different group; if two groups of the plurality of R⁵s or two groups of the plurality of R⁶s are attached to respective positions adjacent to each other on an aromatic ring, the two groups are optionally joined together to form a ring; and M is Ti, Zr, or Hf,
the method comprising:
a step (I) of allowing a ligand represented by the following formula (1a): 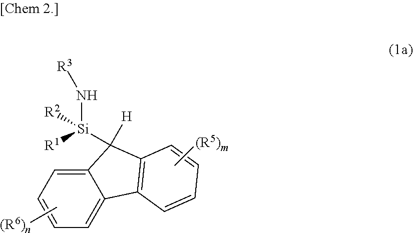
wherein in the formula (1a), R¹, R², R³, R⁵, R⁶, m, and n are as defined in the above, to react with an organolithium compound represented by the following formula (1b):
LiR⁷ (1b)
wherein in the formula (1b), R⁷ represents a hydrocarbon group having 1 to 20 carbon atoms and optionally having at least one hetero atom, and is attached to a lithium atom via a C—Li bond; a step (II) of allowing a product obtained from the step (I) to react with one or more selected from the group consisting of a compound represented by the following formula (1c), a compound represented by the following formula (1d), and a compound represented by the following (1e):
(R⁴)ₚMgX₍₂₋ₚ₎ (1c)
(R⁴)_{q}ZnX_{(2-q)} (1d)
(R⁴)ᵣAlX₍₃₋ᵣ₎ (1e)
wherein in the formulae (1c), (1d), and (1e), R⁴ is as defined in the above; X is a halogen atom; p is 1 or 2; q is 1 or 2; and r is an integer of 1 to 3; and
a step (III) of allowing a product obtained from the step (II) to react with a compound represented by the following formula (1f) in an amount of 1 molar equivalent or more relative to the ligand:
MR⁸₄ (1f)
wherein in the formula (1f), M is as defined in the above; R⁸ represents a halogen atom or a group represented by —OR⁹; R⁹ represents a hydrocarbon group having 1 to 20 carbon atoms and optionally having at least one hetero atom; and R⁹ is attached to an oxygen atom via a C—O bond,
wherein in the step (I), the usage amount of the organolithium compound is 2.0 molar equivalents or more relative to the ligand if R⁴ and R⁷ are the same, and
in the step (I), the usage amount of the organolithium compound is 1.8 molar equivalents or more and 2.2 molar equivalents or less relative to the ligand if R⁴ and R⁷ are not the same, and, in the step (II), a compound selected from the group consisting of the compound represented by the formula (1c), the compound represented by the formula (1d), and the compound represented by the formula (1e) is used in an amount such that the number of moles of the R⁴ group in each of these compounds is larger by 2 times or more than that of the ligand.

2. The method of manufacturing a catalyst according to claim 1, wherein the ligand is a compound represented by the formula (1a-1):

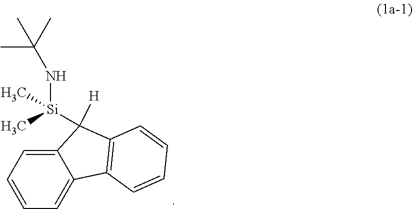

3. The method of manufacturing a catalyst according to claim 1, wherein the product obtained from the step (I) is allowed to react with the compound represented by the formula (1c) in the step (II).

4. The method of manufacturing a catalyst according to claim 1, wherein the compound represented by the formula (1f) is TiCl₄.
